(19) United States
(12) Patent Application Publication
(10) Pub. No.: US 2018/0272260 A1
(43) Pub. Date: Sep. 27, 2018

(54) ULTRA-LOW PRESSURE DROP FLUID FILTERS AND RELATED METHODS

(71) Applicant: Celanese Acetate LLC, Irving, TX (US)

(72) Inventors: Raymond M. Robertson, Blacksburg, VA (US); Ronald F. Hughes, Narrows, VA (US)

(73) Assignee: Celanese Acetate LLC, Irving, TX (US)

(21) Appl. No.: 15/468,224

(22) Filed: Mar. 24, 2017

(51) Int. Cl. B01D 39/16; B01D 39/14; B01D 39/20; C02F 1/00; A24D 3/06; C01D 3/04; C08J 9/26

(52) U.S. Cl. CPC B01D 39/1661; B01D 39/14; B01D 39/2075; C02F 1/001; A24D 3/062; C08J 2323/06; C08J 9/26; B01D 2239/0407; B01D 2239/10; B01D 2239/1258; C01D 3/04

(57) ABSTRACT

A method may comprise: sintering a particulate mixture comprising binder particles at about 5% to about 75% by weight of the particulate mixture and fugitive particles at about 25% to about 90% by weight of the particulate mixture, thereby forming a porous mass; and substantially removing the fugitive particles from the porous mass, thereby forming an ultra-low pressure drop (ULPD) porous mass with fugitive particles at 0% to about 5% by weight of the ULPD porous mass.

### BACKGROUND

The present application relates to fluid filters that are used to remove substances contained with the fluid being filtered and/or to impart substances into the fluid stream passing through the filter.

In some instances, such filters may be used to remove particulates suspended or otherwise retained in a fluid. In such instances, a porous medium filter may be used that allows the fluid (liquid or gas) to flow through the pores freely, but that physically retains particles as the fluid passes through the filter. In other instances, rather than simple physical retention of particles, the filter may include reactive particles that react with a component of the fluid to retain that component. In still other cases, the filter media may itself contain a substance that imparts components into a fluid being passed through the filter. The end use of the filter dictates the required composition of the filter and properties of the filter such as the pore size and the pressure drop across the filter.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates an exemplary method for forming ultra-low pressure drop (ULPD) porous masses according to at least some embodiment of the present disclosure.

FIG. 2 illustrates another exemplary method for forming ULPD porous masses according to at least some embodiment of the present disclosure.

FIG. 3 illustrates yet another exemplary method for forming ULPD porous masses according to at least some embodiment of the present disclosure.

FIG. 4 illustrates the steps that may be included in some of the methods for forming ULPD porous masses of the present disclosure.

FIG. 5 illustrates an exemplary continuous production system for forming ULPD porous masses according to at least some embodiments of the present disclosure.

FIGS. 6-7 illustrate some exemplary filtration products where the ULPD porous masses according to at least some embodiments of the present disclosure may be used.

FIG. 8 is a scanning electron micrograph of a cross-section of a ULPD porous mass according to at least some embodiments of the present disclosure.

### DETAILED DESCRIPTION

The present application relates to fluid filters having an ultra-low pressure drop (“ULPD”) (e.g., less than 1 mm of water/mm of length). The fluid filters described herein are formed by sintering a particulate mixture and, then, removing some of the particles to increase the void volume within the filter and thus decrease the pressure drop across the fluid filter.

As used herein, the terms “particle” and “particulate” may be used interchangeably and include all known shapes of materials, including spherical and/or ovular, substantially spherical and/or ovular, discus and/or platelet, flake, ligamental, acicular, fibrous, polygonal (such as cubic), randomly shaped (such as the shape of crushed rocks), faceted (such as the shape of crystals), or any hybrid thereof.

As used herein, the term “diameter” refers to the smallest cross-sectional diameter of a particle. As used herein, the term “average diameter” for particles refers to a number average of the particle diameters.

The term “porous mass” as used herein refers to a mass comprising a plurality of particles mechanically bound at a plurality of sintered contact points. As used herein, the terms “mechanical bond,” “mechanically bonded,” “physical bond,” and the like refer to a physical connection that holds two particles together. Mechanical bonds may be rigid or flexible depending on the bonding material. Mechanical bonding may or may not involve chemical bonding. Generally, the mechanical binding does not involve an adhesive, though, in some embodiments, an adhesive may be used after mechanical binding to adhere other additives to portions of the porous mass.

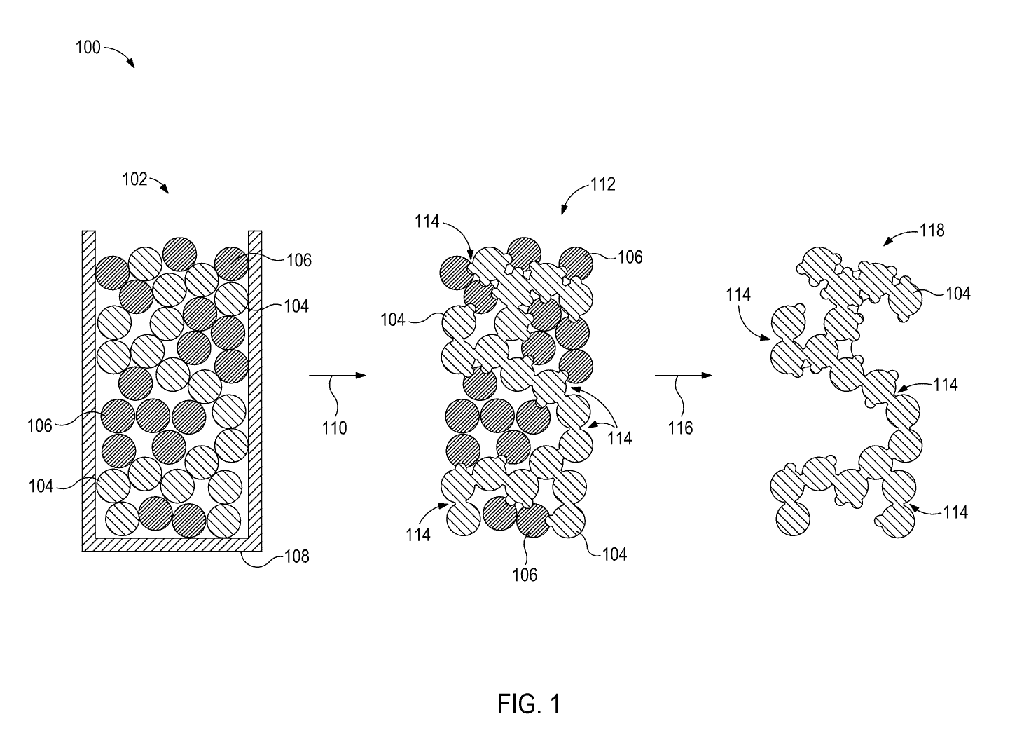

FIG. 1 illustrates an exemplary method 100 according to at least some embodiment of the present disclosure. A particulate mixture 102 comprising binder particles 104 and fugitive particles 106 may be placed in a mold cavity 108. Then, the particulate mixture 102 may be sintered 110. As used herein, the term “sintering” and grammatical variations thereof refers to heating to a temperature between the softening temperature and the melting temperature of a component of the particulate mixture (e.g., the binder particles) in order to form mechanical bonds (also referred to herein as “sintered contact points”) between the particles of the particulate mixture. As used herein, the term “softening temperature” refers to the temperature above which a material becomes pliable and below the melting point of the material.

After sintering 110, a porous mass 112 is formed comprising the binder particles 104 and fugitive particles 106 mechanically bound at sintered contact points 114. Then, the fugitive particles 106 may be substantially removed 116 to produce an ULPD porous mass 118. As used herein, the term “substantially removing” and grammatical variations thereof in relation to fugitive particles refers to removing at least 95% by weight of the fugitive materials, including removing 100% of the fugitive material. Therefore, substantially removing the fugitive particles reduces the amount of fugitive particles to 0% to about 5% by weight of the ULPD porous mass 118. Thus, in embodiments such as those described in FIG. 1 the ULPD porous mass 118 consists of about 95% to 100% binder particles. In some embodiments, the ULPD porous mass 118 as described in FIG. 1 may be said to consist essentially of binder particles, in that only the binder particles themselves materially affect the ability of the filter to act as a filter and remove components of a fluid passing therethrough.

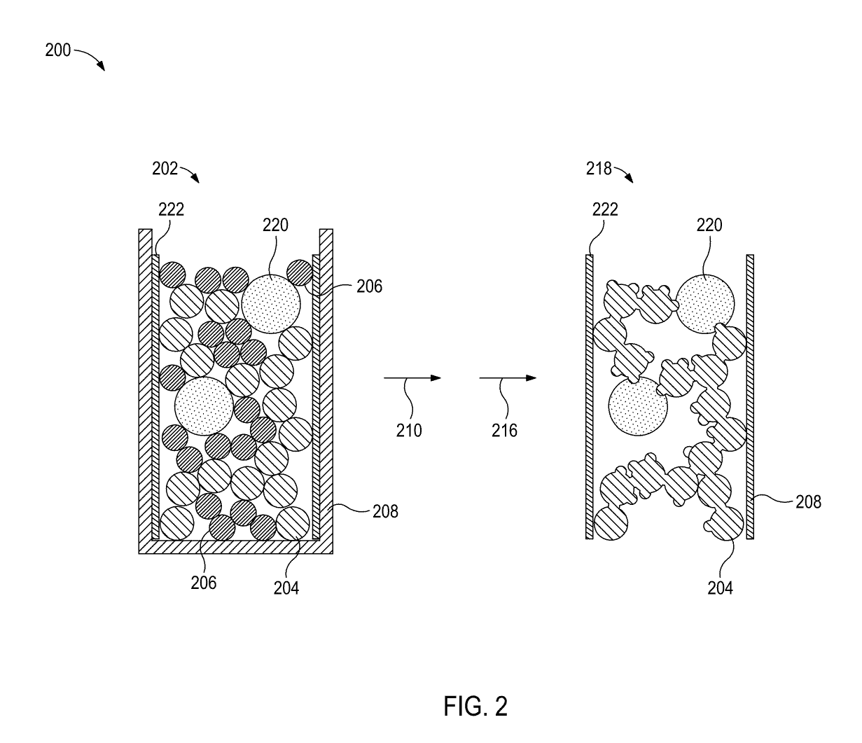

FIG. 2 illustrates another exemplary method 200 according to at least some embodiment of the present disclosure. A particulate mixture 202 comprising binder particles 204, fugitive particles 206, and particulate additives 220 may be placed in a mold cavity 208 lined with a wrapper 222. The wrapper 222 is optional and may, in some instances, not be included. Similarly, in FIG. 1, a wrapper is optional and may, in some instances, be included.

With continued referenced to FIG. 2, then, the particulate mixture 202 may be sintered 210, and the fugitive particles 206 substantially removed 216 to yield an ULPD porous mass 218 having a wrapper 222 thereabout. Thus, in embodiments such as those described in FIG. 2, the ULPD porous mass 218 consists of about 95% to 100% binder particles in combination with particulate additives. In some embodiments, the ULPD porous mass 218 as described in FIG. 2 may be said to consist essentially of binder particles in combination with particulate additives, in that only the binder particles in combination with particulate additives materially affect the ability of the filter to act as a filter, remove components of a fluid passing therethrough, and, depending on the particulate additive, add a component to the fluid passing therethrough.

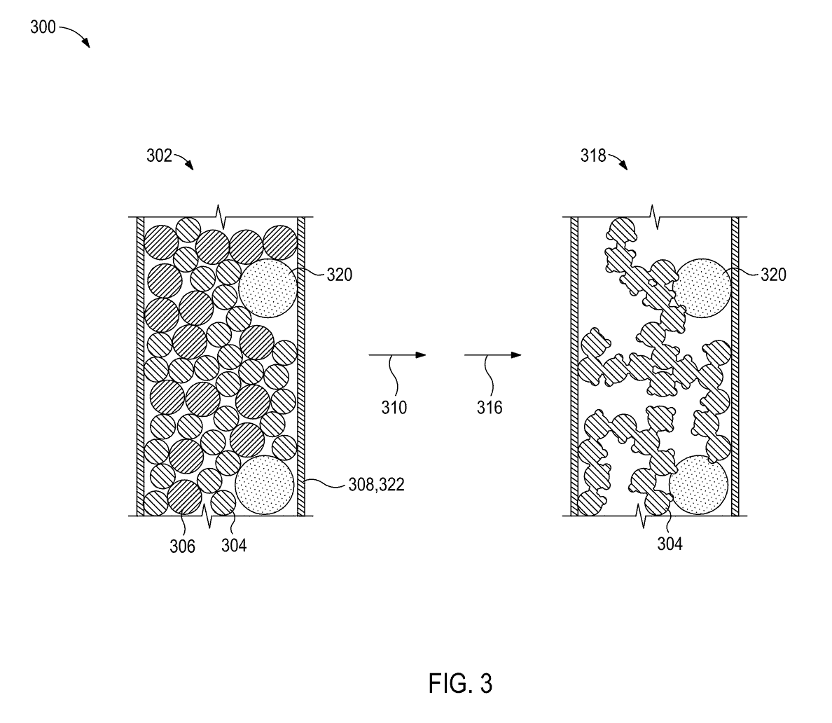

FIG. 3 illustrates yet another exemplary method 300 according to at least some embodiment of the present disclosure. A particulate mixture 302 comprising binder particles 304, fugitive particles 306, and particulate additives 320 may be placed in a mold cavity 308, which in this example is a paper wrapper 322. Then, the particulate mixture 302 may be sintered 310, and the fugitive particles 306 removed 316 to yield an ULPD porous mass 318 having a wrapper 322 thereabout. In this exemplary method 300, the paper wrapper 322 may be continuous (e.g., a 50-ft roll of paper) and rolled into a cylinder, for example. The porous mass (not illustrated) may be cut into a desired length before the fugitive particles 306 are removed 316. Alternatively, the fugitive particles 306 may be removed 316 before cutting.

Examples of binder particles may include, but are not limited to, polyolefins, polyesters, polyamides (or nylons), polyacrylics, polystyrenes, polyvinyls, polytetrafluoroethylene (PTFE), polyether ether ketone (PEEK), any copolymer thereof, any derivative thereof, and any combination thereof. Examples of suitable polyolefins include, but are not limited to, polyethylene, polypropylene, polybutylene, polymethylpentene, any copolymer thereof, any derivative thereof, any combination thereof and the like. Examples of suitable polyethylenes further include low-density polyethylene, linear low-density polyethylene, high-density polyethylene, any copolymer thereof, any derivative thereof, any combination thereof and the like. Examples of suitable polyesters include polyethylene terephthalate, polybutylene terephthalate, polycyclohexylene dimethylene terephthalate, polytrimethylene terephthalate, any copolymer thereof, any derivative thereof, any combination thereof and the like. Examples of suitable polyacrylics include, but are not limited to, polymethyl methacrylate, any copolymer thereof, any derivative thereof, any combination thereof and the like. Examples of suitable polystyrenes include, but are not limited to, polystyrene, acrylonitrile-butadiene-styrene, styrene-acrylonitrile, styrene-butadiene, styrene-maleic anhydride, any copolymer thereof, any derivative thereof, any combination thereof and the like. Examples of suitable polyvinyls include, but are not limited to, ethylene vinyl acetate, ethylene vinyl alcohol, polyvinyl chloride, any copolymer thereof, any derivative thereof, any combination thereof and the like. Examples of suitable cellulosics include, but are not limited to, cellulose acetate, cellulose acetate butyrate, plasticized cellulosics, cellulose propionate, ethyl cellulose, any copolymer thereof, any derivative thereof, any combination thereof and the like. In some embodiments, binder particles may be any copolymer, any derivative, and any combination of the above listed binder particles.

In some embodiments, the binder particles described herein may have a hydrophilic surface treatment. Hydrophilic surface treatments (e.g., oxygenated functionalities like carboxy, hydroxyl, and epoxy) may be achieved by exposure to at least one of chemical oxidizers, flames, ions, plasma, corona discharge, ultraviolet radiation, ozone, and combinations thereof (e.g., ozone and ultraviolet treatments). Because many of the active particles described herein are hydrophilic, either as a function of their composition or adsorbed water, a hydrophilic surface treatment to the binder particles may increase the attraction (e.g., van der Waals, electrostatic, hydrogen bonding, and the like) between the binder particles and the fugitive particles. This enhanced attraction may mitigate segregation of binder particles and the fugitive particles in the particulate mixture, thereby minimizing variability in the pressure drop, integrity, circumference, cross-sectional shape, and other properties of the resultant ULPD porous mass. Further, it has been observed that the enhanced attraction provides for a more homogeneous particulate mixture, which can increase flexibility for filter design (e.g., lowering overall pressure drop, reducing the concentration of the binder particles, or both).

The binder particles may assume any shape. Such shapes include spherical, hyperion, asteroidal, chrondular or interplanetary dust-like, granulated, potato, irregular, and any combination thereof. In preferred embodiments, the binder particles suitable for use in the present invention are non-fibrous. In some embodiments, the binder particles are in the form of a powder, pellet, or particulate.

In some embodiments, the binder particles may have an average diameter ranging from a lower limit of about 1 nm to about 5 mm, including subsets thereof (e.g., about 1 nm to about 500 nm, about 250 nm to about 1 micron, about 500 nm to about 5 microns, about 1 micron to about 250 microns, about 50 microns to about 500 microns, about 100 microns to about 1 mm, about 500 microns to about 2 mm, or about 1 mm to about 5 mm). In some embodiments, the binder particles may be a mixture of particle sizes.

In some embodiments, the binder particles may have a bulk density ranging about 0.10 g/cm³ to about 0.55 g/cm³, including any subset therebetween (e.g., about 0.17 g/cm³ to about 0.50 g/cm³ or about 0.20 g/cm³ to about 0.47 g/cm³).

In some embodiments, the binder particles may exhibit virtually no flow at its melting temperature (i.e., when heated to its melting temperature exhibits little to no polymer flow). Materials meeting these criteria may include, but are not limited to, ultrahigh molecular weight polyethylene (“UHMWPE”), very high molecular weight polyethylene (“VHMWPE”), high molecular weight polyethylene (“HMWPE”), and any combination thereof. As used herein, the term “UHMWPE” refers to polyethylene compositions with weight-average molecular weight of at least about 3×10⁶ g/mol (e.g., about 3×10⁶ g/mol to about 30×10⁶ g/mol, including any subset therebetween). As used herein, the term “VHMWPE” refers to polyethylene compositions with a weight average molecular weight of less than about 3×10⁶ g/mol and more than about 1×10⁶ g/mol, including any subset therebetween. As used herein, the term “HMWPE” refers to polyethylene compositions with weight-average molecular weight of at least about 3×10⁵ g/mol to 1×10⁶ g/mol. For purposes of the present specification, the molecular weights referenced herein are determined in accordance with the Margolies equation (“Margolies molecular weight”). Examples of commercially available polyethylene materials suitable for use as binder particles 104 described herein may include GUR® (UHMWPE, available from Ticona Polymers LLC, DSM, Braskem, Beijing Factory No. 2, Shanghai Chemical, Qilu, Mitsui, and Asahi) including GUR® 2000 series (2105, 2122, 2122-5, 2126), GUR® 4000 series (4120, 4130, 4150, 4170, 4012, 4122-5, 4022-6, 4050-3/4150-3), GUR® 8000 series (8110, 8020), and GUR® X series (X143, X184, X168, X172, X192). Another example of a suitable polyethylene material is that having a molecular weight in the range of about 300,000 g/mol to about 2,000,000 g/mol as determined by ASTM-D 4020, an average particle size between about 300 microns and about 1500 microns, and a bulk density between about 0.25 g/ml and about 0.5 g/ml.

In some embodiments, the binder particles may have a melt flow index (“MFI”), a measure of polymer flow, as measured by ASTM D1238 at 190° C. and 15 kg load of 0 to about 3.5, including subsets therebetween (e.g., 0 to about 0.5, 0.1 to about 1.0, about 0.5 to about 2.0, or about 1.5 to about 3.5). In some embodiments, the ULPD porous masses may comprise a mixture of binder particles having different molecular weights and/or different melt flow indexes.

In some embodiments, the binder particles may have an intrinsic viscosity ranging from about 5 dl/g to about 30 dl/g (including any subset therebetween) and a degree of crystallinity of about 80% or more (e.g., about 80% to 100%, including any subset therebetween) as described in U.S. Patent Application Publication No. 2008/0090081.

In some embodiments, the binder particles may have a molecular weight ranging from about 1×10⁵ g/mol to about 30×10⁶ g/mol, including any subset therebetween (e.g., about 1×10⁵ g/mol to 1×10⁶ g/mol, about 1×10⁶ g/mol to about 3×10⁶ g/mol, or about 3×10⁶ g/mol to about 30×10⁶ g/mol).

In some embodiments, the binder particles may be a combination of various binder particles 104 as distinguished by composition, shape, size, bulk density, MFI, intrinsic viscosity, and the like, and any combination thereof.

Examples of fugitive particles may include, but are not limited to, lithium chloride, sodium chloride, potassium chloride, cesium chloride, magnesium chloride, calcium chloride, manganese chloride, iron (II) chloride, iron (III) chloride, nickel chloride, cobalt chloride, copper chloride, zinc chloride, lithium bromide, sodium bromide, potassium bromide, cesium bromide, magnesium bromide, calcium bromide, manganese bromide, iron (II) bromide, iron (III) bromide, nickel bromide, cobalt bromide, copper bromide, zinc bromide, lithium iodide, sodium iodide, potassium iodide, cesium iodide, magnesium iodide, calcium iodide, manganese iodide, iron (II) iodide, iron (III) iodide, nickel iodide, cobalt iodide, copper iodide, zinc iodide, lithium nitrate, sodium nitrate, potassium nitrate, cesium nitrate, magnesium nitrate, calcium nitrate, manganese nitrate, iron (II) nitrate, iron (III) nitrate, nickel nitrate, cobalt nitrate, copper nitrate, zinc nitrate, lithium sulfate, sodium sulfate, potassium sulfate, cesium sulfate, magnesium sulfate, calcium sulfate, manganese sulfate, iron (II) sulfate, iron (III) sulfate, nickel sulfate, cobalt sulfate, copper sulfate, zinc sulfate, sodium carbonate, potassium carbonate, ammonium carbonate, citric acid, sorbic acid, cellulose acetate, sugar, and the like, and any combination thereof. In some instances, the fugitive particles may be temperature sensitive (e.g., sugar). In such instances, one skilled in the art would recognize a lower maximum sintering temperature should be used to mitigate adversely affecting the fugitive material, for example, caramelizing the sugar.

In some embodiments, the fugitive particles may be soluble in a solvent at room temperature or at an elevated temperature. As used herein, the term “soluble” refers to being able to be dissolved in a solvent at a concentration of greater than 0.5 g per 100 mL of solvent.

In some embodiments, removing the fugitive particles may involve exposing the fugitive particles in the porous mass to the solvent so as to dissolve and/or degrade the fugitive particles. Examples of solvents for solubilizing and/or degrading fugitive particles may include, but are not limited to, water, acetone, methanol, ethanol, propanol, butanol, pentanol, ethylene glycol, propylene glycol, glycerol, acetic acid, formic acid, and the like, and any combination thereof. The solvent should be chosen to not affect or mitigate adverse effects to the other particulates in the particulate mixture including the binder particles and the optional particulate additives.

When particulate additives described herein are used, the solvent should be chosen so as to mitigate adverse effects to the particulate additives.

After exposure to the solvent, the resultant ULPD porous mass may be dried or otherwise treated to remove any remaining solvent from the porous structure of the ULPD porous mass.

In some embodiments, the particulate mixture may optionally include one or more types of additives (e.g., particulate additives 220, 320 of FIGS. 2 and 3, respectively, or compounds that at least partially coat the binder particles like adhesives). Suitable additives may include, but not be limited to, active particles, active compounds, organic particles, ionic resins, zeolites, nanoparticles, microwave enhancement additives, ceramic particles, glass beads, softening agents, plasticizers, pigments, dyes, controlled release vesicles, adhesives, tackifiers, surface modification agents, vitamins, peroxides, biocides, antifungals, antimicrobials, antistatic agents, flame retardants, degradation agents, and any combination thereof. In some instances, after forming a ULPD porous mass, the additives may be added to the ULPD. For example, a ULPD may be sprayed, submerged, or otherwise contacted in a fluid having an additive like a pigment, an adhesive, a vitamin, or the like therein to at least partially coat the binder and/or have the binder or other particulate absorb the additive.

Active particles and active compounds may be any material adapted to enhance the fluid flowing thereover. Adapted to enhance fluid flowing thereover refers to any material that can remove, reduce, or add components to a fluid stream. The removal or reduction (or addition) may be selective. By way of example, in a smoke stream from a smoking device like a cigarette, the following compounds may be selectively removed or reduced: acetaldehyde, acetamide, acetone, acrolein, acrylamide, acrylonitrile, aflatoxin B-1,4-aminobiphenyl, 1-aminonaphthalene, 2-aminonaphthalene, ammonia, ammonium salts, anabasine, anatabine, 0-anisidine, arsenic, A-a-C, benz[a]anthracene, benz[b]fluoroanthene, benz[j]aceanthrylene, benz[k]fluoroanthene, benzene, benzo(b)furan, benzo[a]pyrene, benzo[c]phenanthrene, beryllium, 1,3-butadiene, butyraldehyde, cadmium, caffeic acid, carbon monoxide, catechol, chlorinated dioxins/furans, chromium, chrysene, cobalt, coumarin, a cresol, crotonaldehyde, cyclopenta[c,d]pyrene, di benz(a,h)acridine, dibenz(a,j)acridine, dibenz[a,h]anthracene, dibenzo(c,g)carbazole, dibenzo[a,e]pyrene, dibenzo[a,h]pyrene, dibenzo[a,i]pyrene, dibenzo[a,l]pyrene, 2,6-dimethylaniline, ethyl carbamate (urethane), ethylbenzene, ethylene oxide, eugenol, formaldehyde, furan, glu-P-1, glu-P-2, hydrazine, hydrogen cyanide, hydroquinone, indeno[1,2,3-cd]pyrene, IQ, isoprene, lead, MeA-a-C, mercury, methyl ethyl ketone, 5-methylchrysene, 4-(methylnitrosamino)-1-(3-pyridyl)-1-butanone (N NK), 4-(methylnitrosamino)-1-(3-pyridyl)-1-butanol (NNAL), naphthalene, nickel, nicotine, nitrate, nitric oxide, a nitrogen oxide, nitrite, nitrobenzene, nitromethane, 2-nitropropane, N-nitrosoanabasine (NAB), N-nitrosodiethanolamine (NDELA), N-nitrosodiethylamine, N-nitrosodimethylamine (NDMA), N-nitrosoethylmethylamine, N-nitrosomorpholine (NMOR), N-nitrosonornicotine (NNN), N-nitrosopiperidine (NPIP), N-nitrosopyrrolidine (NPYR), N-nitrososarcosine (NSAR), phenol, PhIP, polonium-210 (radio-isotope), propionaldehyde, propylene oxide, pyridine, quinoline, resorcinol, selenium, styrene, tar, 2-toluidine, toluene, Trp-P-1, Trp-P-2, uranium-235 (radio-isotope), uranium-238 (radio-isotope), vinyl acetate, vinyl chloride, and the like, and any combination thereof. In another example, in a water stream, the following compounds may be selectively removed or reduced: fluoride, chlorine, lead, mercury, arsenic, perchlorate, dioxins, halogenated hydrocarbons (e.g., polychlorinated biphenyls, dichloro-diphenyl-trichloroethane, hexachlorobenzene, dimethyl tetrachloroterephthalate, and trihalomethanes), and methyl tertiary-butyl ether, bisphenol A, and the like, and any combination thereof.

By way of another nonlimiting example, water may be contaminated with a variety of bacteria, viruses, parasites, chemicals, and the like. Active particles and active compounds may be included in the particulate mixtures and ULPD porous masses described herein to reduce the concentration of these contaminants in the water. Because the ULPD porous mass is ultra-low pressure drop, an exemplary application may include using the ULPD porous mass in a device that allows a person to physically suck water through the ULPD porous mass so as to reduce the contaminants in the water. In another example, the water may be pushed or pulled through the ULPD porous mass using pumps to reduce the contaminants in the water, which in some instances may be to a level suitable for drinking. In yet another example, ULPD porous masses may be used in filter in a gravity filtration apparatus, which may be useful in filtering water or other liquids to remove unwanted contaminants.

One example of an active particle is activated carbon (or activated charcoal or active coal). The activated carbon may be low activity (about 50% to about 75% CCl₄ adsorption) or high activity (about 75% to about 95% CCl₄ adsorption) or a combination of both. Activated carbons may include those derived from (e.g., pyrolyzed from) coconut shells, coal, synthetic resins, and the like. Examples of commercially available carbon may include, but are not limited to, product grades offered by Calgon, Jacobi, Norit, and other similar suppliers. By way of nonlimiting example, one of Norit's granular activated carbon products is NORIT® GCN 3070. In another example, Jacobi offers activated carbons in grades that include CZ, CS, CR, CT, CX, and GA-Plus in a variety of particles sizes.

In some embodiments, the active carbon may be nano-scaled carbon particles, such as carbon nanotubes of any number of walls, carbon nanohorns, bamboo-like carbon nanostructures, fullerenes and fullerene aggregates, and graphene including few layer graphene and oxidized graphene. Other examples of active particles may include, but are not limited to, ion exchange resins, desiccants, silicates, molecular sieves, silica gels, activated alumina, zeolites, perlite, sepiolite, Fuller's Earth, magnesium silicate, metal oxides (e.g., iron oxide, iron oxide nanoparticles like about 12 nm Fe₃O₄, manganese oxide, copper oxide, and aluminum oxide), gold, platinum, iodine pentoxide, phosphorus pentoxide, nanoparticles (e.g., metal nanoparticles like gold and silver; metal oxide nanoparticles like alumina; magnetic, paramagnetic, and superparamagnetic nanoparticles like gadolinium oxide, various crystal structures of iron oxide like hematite and magnetite, gado-nanotubes, and endofullerenes like Gd@C₆₀; and core-shell and onionated nanoparticles like gold and silver nanoshells, onionated iron oxide, and others nanoparticles or microparticles with an outer shell of any of said materials) and any combination of the foregoing (including activated carbon). Ion exchange resins include, for example, a polymer with a backbone, such as styrene-divinyl benzene (DVB) copolymer, acrylates, methacrylates, phenol formaldehyde condensates, and epichlorohydrin amine condensates; and a plurality of electrically charged functional groups attached to the polymer backbone. In some embodiments, the active particles are a combination of various active particles. In some embodiments, the ULPD porous mass may comprise multiple active particles. In some embodiments, an active particle may comprise at least one element selected from the group of active particles disclosed herein. It should be noted that “element” is being used as a general term to describe items in a list. In some embodiments, the active particles are combined with at least one flavorant.

Suitable active particles may have a diameter (smallest cross-sectional distance) of about 0.1 nm to about 5 mm, including subsets therebetween (e.g., about 0.1 nm to about 25 about, about 10 nm to about 100 nm, about 25 nm to about 500 nm, about 250 nm to about 1 micron, about 500 nm to about 5 microns, about 1 micron to about 50 microns, about 25 microns to about 250 microns, about 100 microns to about 1 mm, or about 500 microns to about 5 mm). In some embodiments, the active particles may be a mixture of particle sizes.

Examples of active compounds may include, but are not limited to, triacetin, malic acid, potassium carbonate, citric acid, tartaric acid, lactic acid, ascorbic acid, polyethyleneimine, cyclodextrin, sodium hydroxide, sulphamic acid, sodium sulphamate, polyvinyl acetate, carboxylated acrylate, liquid amines, vitamin E, triethyl citrate, acetyl triethyl citrate, tributyl citrate acetyl tributyl citrate, acetyl tri-2-ethylhexyl, non-ionic surfactants (e.g., polyoxyethylene (POE) compounds, POE (4) lauryl ether, POE 20 sorbitan monolaurate, POE (4) sorbitan monolaurate, POE (6) sorbitol, POE (20) C16, C10-C13 phosphates, and any combination thereof. Depending on the sintering temperature and fluid used to remove the fugitive particles, the active compounds may be included in the particulate mixture and/or added to the ULPD porous mass after removal of the fugitive particles.

In some embodiments, organic particles for use in ULPD porous masses described herein may be produced by grinding natural compositions. Examples of natural compositions of organic particles may include, but are not limited to, cloves, tobacco, coffee beans, cocoa, cinnamon, vanilla, tea, green tea, black tea, bay leaves, citrus peels (e.g., orange, lemon, lime, grapefruit, and the like), cumin, chili peppers, chili powder, red pepper, eucalyptus, peppermint, curry, anise, dill, fennel, allspice, basil, rosemary, pepper, caraway seeds, cilantro, garlic, mustard, nutmeg, thyme, turmeric, oregano, other spices, hops, other grains, sugar, and the like, and any combination thereof.

In some embodiments, the increased temperature of the fluid stream passing through the ULPD porous mass may enhance the release of flavorant from the organic particles.

In some embodiments, the organic particles may have a diameter (smallest cross-sectional distance) of about 100 microns to about 1.5 mm, including subsets therebetween (e.g., about 100 microns to about 500 microns, about 250 microns to about 1 mm, or about 500 microns to about 1.5 mm). In some embodiments, the organic particles may be a mixture of particle sizes.

Other examples of additives may be found in United States Patent Application Publication No. 2014/0076340, which is incorporated by reference herein.

Methods of forming the porous masses may include those for forming porous masses in United States Patent Application Publication No. 2014/0076340, which is incorporated by reference herein.

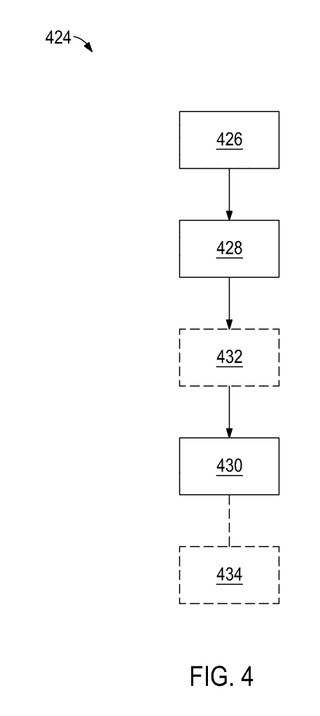

FIG. 4 illustrates the steps that may be included in some of the methods 424 for forming ULPD porous masses of the present disclosure. Generally, methods 424 may involve introducing 426 a particulate mixture (e.g., particulate mixture 102, 202, 302 of FIG. 1, 2, or 3, respectively) into a mold cavity and heating 428 (or otherwise sintering) the particulate mixture to a sintering temperature between the softening temperature and melting temperature of the binder particles so as to form sintered contact points between the various particles in the particulate mixture. The result is a porous mass.

Introducing 426 the particulate mixture into a mold cavity may involve any suitable feeder system/method including, but not limited to, hand feeding, volumetric feeders, mass flow feeders, gravimetric feeders, pressurized vessel (e.g., pressurized hopper or pressurized tank), augers or screws, chutes, slides, conveyors, tubes, conduits, channels, and the like, and any combination thereof. In some embodiments, the material path may include a mechanical component between the hopper and the mold cavity including, but not limited to, garnitures, compression molds, flow-through compression molds, ram presses, pistons, shakers, extruders, twin screw extruders, solid state extruders, and the like, and any combination thereof. In some embodiments, feeding may involve, but not be limited to, forced feeding, controlled rate feeding, volumetric feeding, mass flow feeding, gravimetric feeding, vacuum-assisted feeding, fluidized powder feeding, pneumatic dense phase feeding (e.g., via slug flow, dune or irregular dune flow, shearing-bed or ripple flow, and extrusion flow), pneumatic dilute phase feeding, and any combination thereof. In some preferred embodiments, pneumatic dense phase feeding may advantageously allow for high-throughput processing. Pneumatic dense phase feeding has been performed at high flow rates with large diameter outlets, but here has unexpectedly been shown to be effective with small diameters at high speeds. For example, surprisingly, the use of pneumatic dense phase feeding has been demonstrated at small diameters (e.g., about 5 mm to about 25 mm and about 5 mm to about 10 mm) with high-throughput (e.g., about 500 m/min for a mold cavity having about 6.1 mm diameter). In some instances, pneumatic dense phase feeding may be at a rate of 150 m/min or greater (e.g., up to about 80 m/min) with a mold cavity diameter of about 5 mm to about 25 mm, including subsets therebetween.

The mold cavity may have any suitable shape, which depends on the application of the ULPD porous mass. A mold cavity may have any cross-sectional shape including, but not limited to, circular, substantially circular, ovular, substantially ovular, polygonal (like triangular, square, rectangular, pentagonal, and so on), polygonal with rounded edges, donut, and the like, or any hybrid thereof. In some embodiments, ULPD porous masses may have a cross-sectional shape comprising holes, which may be achieved by the use of one or more dies, by machining, by an appropriately shaped mold cavity, or any other suitable method (e.g., degradation of a degradable material). In some embodiments, ULPD porous masses may have a specific shape for placement in a holder (e.g., a cigarette holder, a pipe, a water filter cartridge, and the like). When discussing the shape of a porous mass and/or ULPD porous mass, the shape may be referred to in terms of diameter (the smallest cross-sectional distance perpendicular to the fluid flow direction), circumference (the perimeter the cross-sectional shape that is perpendicular to the fluid flow direction), and height, length, or thickness (greatest distance along the direction of flow). For example, small diameter cylinders (e.g., about 5 mm to about 25 mm diameter) may be suitable for smoking device filters. Such shapes may be formed to have or be further cut to a suitable length (e.g., about 3 mm to about 30 mm long). In another example, fluid filters may be flat cylinders with exemplary dimensions of about 10 mm to about 30 cm in diameter and about 5 mm to about 5 cm in height. In yet another example, fluid filters may have a hollow cylindrical shape with exemplary dimensions of a wall thickness of about 5 mm to about 10 cm. In another example, fluid filters may be sheets (e.g., cut or formed to rectangular, square, or circular shapes) with exemplary dimensions of a thickness of about 5 mm to about 50 mm.

The mold cavity may be a single piece or a collection of single pieces, either with or without end caps, plates, or plugs. In some embodiments, a mold cavity may be multiple mold cavity parts that when assembled form a mold cavity. In some embodiments, mold cavity parts may be brought together with the assistance of conveyors, belts, and the like. In some embodiments, mold cavity parts may be stationary along the material path and configured to allow for conveyors, belts, and the like to pass therethrough, where the mold cavity may expand and contract radially to provide a desired level of compression to the particulate mixture.

In some embodiments, the mold cavity may be at least partially lined with wrappers and/or coated with release agents (e.g., as illustrated in FIG. 2). In some embodiments, wrappers may be individual wrappers (e.g., pieces of paper). In some embodiments, wrappers may be spoolable-length wrappers (e.g., a 50 ft roll of paper). In some embodiments, the mold cavity 108 may be formed by the wrapper.

In some embodiments, the mold cavity may be lined with more than one wrapper. In some embodiments, forming porous masses may include lining the mold cavity with a wrapper(s). In some embodiments, forming porous masses may include wrapping the particulate mixture with wrappers so that the wrapper effectively forms the mold cavity. In such embodiments, the wrapper may be performed as the mold cavity, formed as the mold cavity in the presence of the particulate mixture, or wrapped around particulate mixture that is in a preformed shape (e.g., with the aid of a tackifier). In some embodiments, wrappers may be continuously fed through the mold cavity. Wrappers may be useful for holding the porous masses and ULPD porous masses in a shape, releasing the porous masses from the mold cavity, assisting in passing particulate mixture through the mold cavity, capable of protecting the porous masses and ULPD porous masses during handling and/or shipment, and any combination thereof.

Suitable wrappers may include, but not be limited to, papers (e.g., wood-based papers, papers containing flax, flax papers, papers produced from other natural or synthetic fibers, functionalized papers, special marking papers, colorized papers), plastics (e.g., fluorinated polymers like polytetrafluoroethylene, silicone), films, coated papers, coated plastics, coated films, and the like, and any combination thereof. In some embodiments, wrappers may be papers suitable for use in smoking device filters.

Suitable release agents may be chemical release agents or physical release agents. Nonlimiting examples of chemical release agents may include oils, oil-based solutions and/or suspensions, soapy solutions and/or suspensions, coatings bonded to the mold cavity 108 surface, and the like, and any combination thereof. Nonlimiting examples of physical release agents may include papers, plastics, and any combination thereof. Physical release agents, which may be referred to as release wrappers, may be implemented similar to wrappers as described herein.

Heating 428 (or otherwise sintering) the particulate mixture is to a sintering temperature that is between the softening temperature and melting temperature of the binder particles so as to form sintered contact points between the various particles in the particulate mixture. Heating 428 the particulate mixture may be to a sintering temperature between about 90° C. and about 300° C., including any subset therebetween (e.g., about 90° C. and about 150° C., about 150° C. and about 300° C., about 125° C. and about 200° C., or about 175° C. and about 250° C.).

Heating 428 may be achieved with radiant heat, conductive heat, convective heat, and any combination thereof. Heating 428 may use thermal sources including, but not limited to, heated fluids internal to the mold cavity, heated fluids external to the mold cavity, steam, heated inert gases, secondary radiation from a component of the particulate mixture (e.g., nanoparticles, active particles, and the like), ovens, furnaces, flames, conductive or thermoelectric materials, ultrasonics, and the like, and any combination thereof. By way of nonlimiting example, heating 428 may involve a convection oven or heating block. Another nonlimiting example may involve heating with microwave energy (single-mode or multi-mode applicator). In another nonlimiting example, heating 428 may involve passing heated air, nitrogen, or other gas through the particulate mixture while in the mold cavity. In some embodiments, heated inert gases may be used to mitigate any unwanted oxidation of components of the particulate mixture. Secondary radiation from a component of the particulate mixture (e.g., nanoparticles, active particles, and the like) may, in some embodiments, be achieved by irradiating the component with electromagnetic radiation (e.g., gamma-rays, x-rays, UV light, visible light, IR light, microwaves, radio waves, and/or long radio waves). By way of nonlimiting example, the particulate mixture may comprise carbon nanotubes that when irradiated with radio frequency waves emit heat. In another nonlimiting example, the particulate mixture may comprise active particles like carbon particles that are capable of converting microwave irradiation into heat and cause sintering. In some embodiments, the electromagnetic radiation may be tuned by the frequency and power level so as to appropriately interact with the component of choice. For example, activated carbon may be used in conjunction with microwaves at a frequency ranging from about 900 MHz to about 2500 MHz with a fixed or adjustable power setting that is selected to match a target rate of heating.

During heating 428, the binder particles may retain their original physical shape (or substantially retain their original shape, e.g., no more that 10% variation (e.g., shrinkage) in shape from original).

With continued reference to FIG. 4, the methods 424 further involve removing 430 (or substantially removing) the fugitive particles from the porous mass (e.g., by exposing the fugitive particles in the porous mass to a solvent so as to dissolve and/or degrade the fugitive particles). Exposure may include, for example, soaking the porous mass in the solvent, passing the solvent through the porous mass, and the like.

In some instances, exposure of the fugitive particles in the porous mass to a solvent may be performed at elevated temperatures to allow for or enhance dissolution/degradation of the fugitive particles. For example, the solubility of many salts in water increases with temperatures. Therefore, some methods may include exposing the fugitive particles to water at a temperature greater than ambient to decrease the time of exposure. In another example, some polymeric fugitive particles may be degraded by acids and increasing the temperature may increase the rate of degradation. In some instances, the fugitive particles may be exposed to a solvent at a temperature at or above ambient temperature (e.g., 25° C. or greater). In some instances, the solvent may be at or within 10% of the boiling temperature of the solvent. Exemplary temperatures for the solvent may include, but are not limited to, about ambient temperature to about 250° C. provided the temperature of the solvent is less than the softening temperature of the binder particles. The solvent and temperature of exposure should be chosen to minimally, if at all, adversely affect with the binder particles and the sintered contact points formed during heating 428.

Depending on the configuration of the mold cavity, the porous mass may be removed from the mold cavity before or remain in the mold cavity during removing 430 of the fugitive particles. Optionally, further processing 432 may occur before removing 430 the fugitive particles. Further processing 432 may include one or more of: cutting or otherwise shaping the porous mass to a desired shape and size, a wrapper, and the like. Additionally, after removing 430 of the fugitive particles from the porous mass, the methods 424 may optionally include further processing 434, which may include one or more of: cutting or otherwise shaping to a desired shape and size, removing a wrapper, and the like.

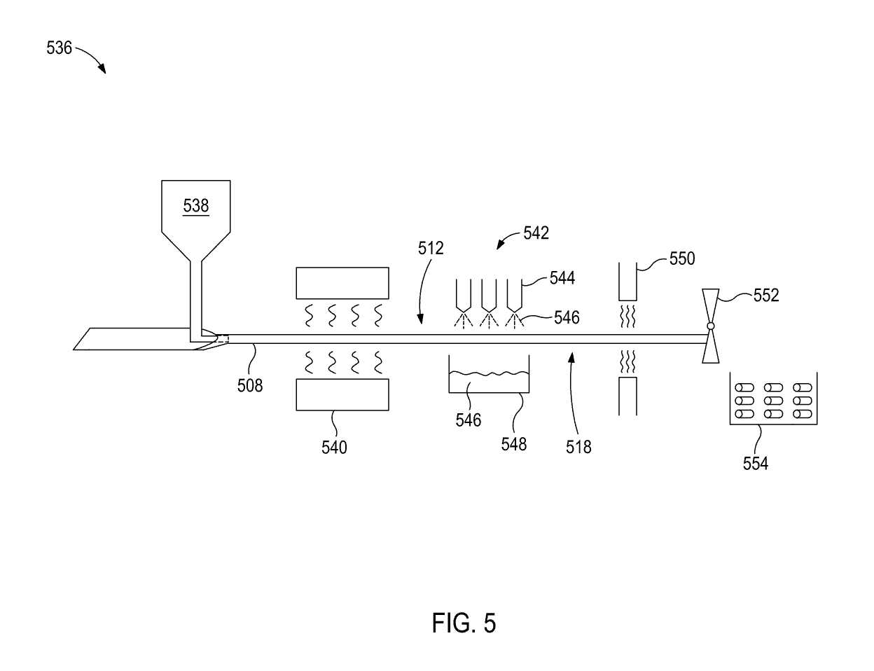

In some instances, exposure of the fugitive particles in the porous mass to a solvent may be performed in a continuous production system. An exemplary continuous production system 536 is illustrated in FIG. 5. The system 536 includes a feeding system 538 that contains the particulate mixture and introduces the particulate mixture into a mold cavity 508. As illustrated, the mold cavity 508 is paper rolled into a cylindrical shape. After the particulate mixture is within the mold cavity 508, a heater 540 increases the temperature of the particulate mixture (i.e., heating or otherwise sintering) to form the sintered contact points described herein, which produces a porous mass 512. To at least substantially remove the fugitive particles from the porous mass 512, the porous mass may be conveyed to a washing station 542 where jets 544 (or the like) spray a solvent on and through the porous mass 512. The solvent 546 with dissolved portions of the fugitive particles may then be collected in a container 548. Optionally, the solvent 546 from the container may be (1) reused to dissolve additional portions of the fugitive particles or (2) cleaned to remove portions of the fugitive particles and, then, reused to dissolve additional portions.

After removal of the fugitive particles, the porous mass 518 may be conveyed to a dryer 550 to at least substantially remove solvent in the porous mass 518. Finally, the porous mass 518 may be cut to desired lengths using a cutter 552 and collected in a container 554.

The resultant ULPD porous mass from any of the methods described herein (continuous or otherwise) may have an encapsulated pressure drop (“EPD”) less than about 1 mm H₂O/mm length of ULPD porous mass (e.g., about 0.01 mm H₂O/mm length of ULPD porous mass to about 1 mm H₂O/mm length of ULPD porous mass, about 0.01 mm H₂O/mm length of ULPD porous mass to about 0.1 mm H₂O/mm length of ULPD porous mass, or about 0.25 mm H₂O/mm length of ULPD porous mass to about 1 mm H₂O/mm length of ULPD porous mass). EPD for a ULPD porous mass can be measured using the CORESTA (“Cooperation Centre for Scientific Research Relative to Tobacco”) Recommended Method No. 41, dated June 2007. It should be noted that the pressure drop of a device or system utilizing the ULPD porous mass may be different than the pressure drop of the ULPD porous mass. For example, a filtration system having multiple filters in series may utilize a ULPD porous mass and a filter having a higher EPD (e.g., 2 mm H₂O/mm length or greater), where the filtration system operates at the higher EPD.

The ULPD porous masses described herein may be incorporated into a plurality of filtration products. Exemplary products may include, but are not limited to, smoking device filters (e.g., cigarette filters, hookah filters, or cigar filters), water filters (e.g., cartridge filters or solid block filters), air filters (e.g., heating, ventilation, and air-conditioning (HVAC) filters) and the like.

In some instances, the ULPD porous masses described herein may be used in combination with another filter. For example, a ULPD porous mass may be a segment in a segmented smoking device filter (e.g., as illustrated in FIG. 5). In another example, a ULPD porous mass may be used upstream of a filter having a smaller pore size so that the ULPD porous mass filters large particles and the second filter filters smaller particles.

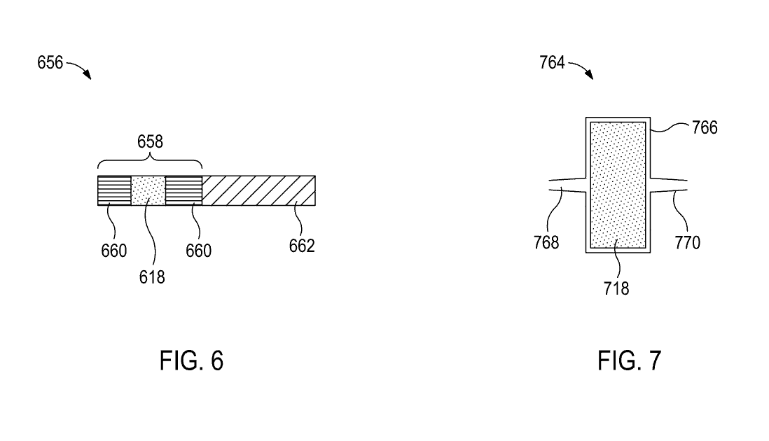

FIGS. 6-7 illustrate some exemplary filtration products where the ULPD porous masses of the present disclosure may be used. For example, FIG. 6 illustrates a smoking device 656 with a segmented filter 658 that includes two filter segments 660 (e.g., a cellulose acetate tow or paper) with a ULPD porous mass 618 therebetween. The segmented filter 658 is adjoined to and in fluid communication with a tobacco rod 662 to form the smoking device 656, specifically illustrated as a cigarette. In some instances, one or more ULPD porous masses may be used in a segmented filter in fluid communication with a smokeable substance (e.g., a segmented filter in a pipe, hookah, or other smoking device that when used to smoke the smokeable substance requires the smoke pass through the segmented filter before reaching the operator/smoker).

FIG. 7 illustrates a filter 764 that includes a housing 766 containing a ULPD porous mass and having an inlet 768 and an outlet 770. The filter 764 may be used for filtering gases or liquids.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Embodiments described herein include, but are not limited to, Embodiment A, Embodiment B, and Embodiment C.

Embodiment A is a method comprising: sintering a particulate mixture comprising binder particles at about 5% to about 75% by weight of the particulate mixture and fugitive particles at about 25% to about 90% by weight of the particulate mixture, thereby forming a porous mass; and substantially removing the fugitive particles from the porous mass, thereby forming an ultra-low pressure drop (ULPD) porous mass with fugitive particles at 0% to about 5% by weight of the ULPD porous mass. Embodiment A may optionally include one or more of the following: Element 1: wherein the ULPD porous mass has an encapsulated pressure drop of less than 1 mm of water/mm length of the ULPD porous mass; Element 2: wherein the fugitive particles are soluble in a solvent selected from the group consisting of water, acetone, methanol, ethanol, propanol, butanol, pentanol, ethylene glycol, propylene glycol, glycerol, acetic acid, formic acid, and any combination thereof, and wherein removing the fugitive particles involves exposing the fugitive particles in the porous mass to the solvent; Element 3: Element 2 and wherein the solvent is at a temperature at or above about 50° C.; Element 4: Element 2 and wherein the solvent is at a temperature at or above about 100° C.; Element 5: wherein the fugitive particles are degradable by a solvent selected from the group consisting of water, acetone, methanol, ethanol, propanol, butanol, pentanol, ethylene glycol, propylene glycol, glycerol, acetic acid, formic acid, and any combination thereof, and wherein removing the fugitive particles involves exposing the fugitive particles in the porous mass to the solvent; Element 6: wherein the fugitive particles comprise at least one selected from the group consisting of lithium chloride, sodium chloride, potassium chloride, cesium chloride, magnesium chloride, calcium chloride, manganese chloride, iron (II) chloride, iron (III) chloride, nickel chloride, cobalt chloride, copper chloride, zinc chloride, lithium bromide, sodium bromide, potassium bromide, cesium bromide, magnesium bromide, calcium bromide, manganese bromide, iron (II) bromide, iron (III) bromide, nickel bromide, cobalt bromide, copper bromide, zinc bromide, lithium iodide, sodium iodide, potassium iodide, cesium iodide, magnesium iodide, calcium iodide, manganese iodide, iron (II) iodide, iron (III) iodide, nickel iodide, cobalt iodide, copper iodide, zinc iodide, lithium nitrate, sodium nitrate, potassium nitrate, cesium nitrate, magnesium nitrate, calcium nitrate, manganese nitrate, iron (II) nitrate, iron (III) nitrate, nickel nitrate, cobalt nitrate, copper nitrate, zinc nitrate, lithium sulfate, sodium sulfate, potassium sulfate, cesium sulfate, magnesium sulfate, calcium sulfate, manganese sulfate, iron (II) sulfate, iron (III) sulfate, nickel sulfate, cobalt sulfate, copper sulfate, zinc sulfate, sodium carbonate, potassium carbonate, ammonium carbonate, citric acid, sorbic acid, cellulose acetate, sugar, and any combination thereof; Element 7: wherein the fugitive particles have an average diameter of about 100 microns to about 1 mm; Element 8: the method further comprising: placing the particulate mixture in a mold cavity before sintering; Element 9: placing the particulate mixture in a mold cavity lined with a wrapper before sintering; Element 10: wherein the particulate mixture further comprises a particulate additive at about 5% to about 70% by weight of the particulate mixture; Element 11: Element 10 and wherein the porous mass consists of the binder particles, the fugitive particles, and the particulate additive; Element 12: Element 10 and wherein the particulate additive comprises at least one selected from the group consisting of active particles, organic particles, and any combination thereof; Element 13: the method further comprising: adding an active compound to the ULPD porous mass; and Element 14: the method further comprising: forming a product comprising the ULPD porous mass, the product being selected from the group consisting of a smoking device filter and a water filter. Exemplary combinations include, but are not limited to: Element 1 in combination with one or more of Elements 2-14; Element 2 (and optionally Element 3 or Element 4) in combination with one or more of Elements 5-14; Element 5 in combination with one or more of Elements 6-14; Element 6 in combination with one or more of Elements 7-14; Element 7 in combination with one or more of Elements 8-14; Element 8 or Element 9 in combination with one or more of Elements 10-14; Element 10 (and optionally Element 11 or Element 12) in combination with one or more of Elements 13-14; and Elements 13 and 14 in combination.

Embodiment B is a method comprising: introducing a particulate mixture into a mold cavity, the particulate mixture comprising binder particles at about 5% to about 75% by weight of the particulate mixture, fugitive particles at about 25% to about 90% by weight of the particulate mixture, and a particulate additive at about 5% to about 70% by weight of the particulate mixture; sintering the particulate mixture while in the mold cavity, thereby forming a porous mass; exposing the porous mass to a solvent to substantially remove the fugitive particles from the porous mass, thereby forming an ultra-low pressure drop (ULPD) porous mass with fugitive particles at 0% to about 5% by weight of the ULPD porous mass and having an encapsulated pressure drop of less than 1 mm of water/mm length of the ULPD porous mass; and drying the porous mass. Embodiment B may optionally include one or more of the following: Element 6; Element 7; Element 10; Element 11; Element 12; Element 13; Element 14; Element 15: wherein the solvent comprises one or more selected from the group consisting of water, acetone, methanol, ethanol, propanol, butanol, pentanol, ethylene glycol, propylene glycol, glycerol, acetic acid, formic acid, and any combination thereof; Element 16: wherein the solvent is at a temperature at or above about 50° C.; Element 17: wherein the solvent is at a temperature at or above about 100° C.; Element 18: wherein the mold cavity is paper; and Element 19: wherein the mold cavity is lined with paper. Exemplary combinations include, but are not limited to: Element 6 and/or Element 7 in combination with one or more of Elements 10-19; Element 10 (and optionally Element 11 or Element 12) in combination with one or more of Elements 13-19; Element 13 in combination with one or more of Elements 14-19; Element 14 in combination with one or more of Elements 15-19; and Element 15 (and optionally Element 16 or Element 17) in combination with Element 18 or Element 19.

Embodiment C is a composition comprising: an ultra-low pressure drop (ULPD) porous mass consisting of a plurality of binder particles mechanically bound at a plurality of sintered contact points, wherein the ULPD porous mass has a pressure drop across of less than 1 mm of water/mm of ULPD porous mass length. Embodiment C may optionally include one or more of the following: Element 20: the composition further comprising a wrapper (e.g., a paper wrapper); Element 21: a liquid filter (or liquid filter system) comprising the composition; Element 22: a gas filter (or gas filter system) comprising the composition; and Element 23: a smoking device filter (or smoking device) comprising the composition. Exemplary combinations include, but are not limited to: Element 20 in combination with one of Elements 21-23.

To facilitate a better understanding of the embodiments of the present invention, the following examples of preferred or representative embodiments are given. In no way should the following examples be read to limit, or to define, the scope of the invention.

### EXAMPLES

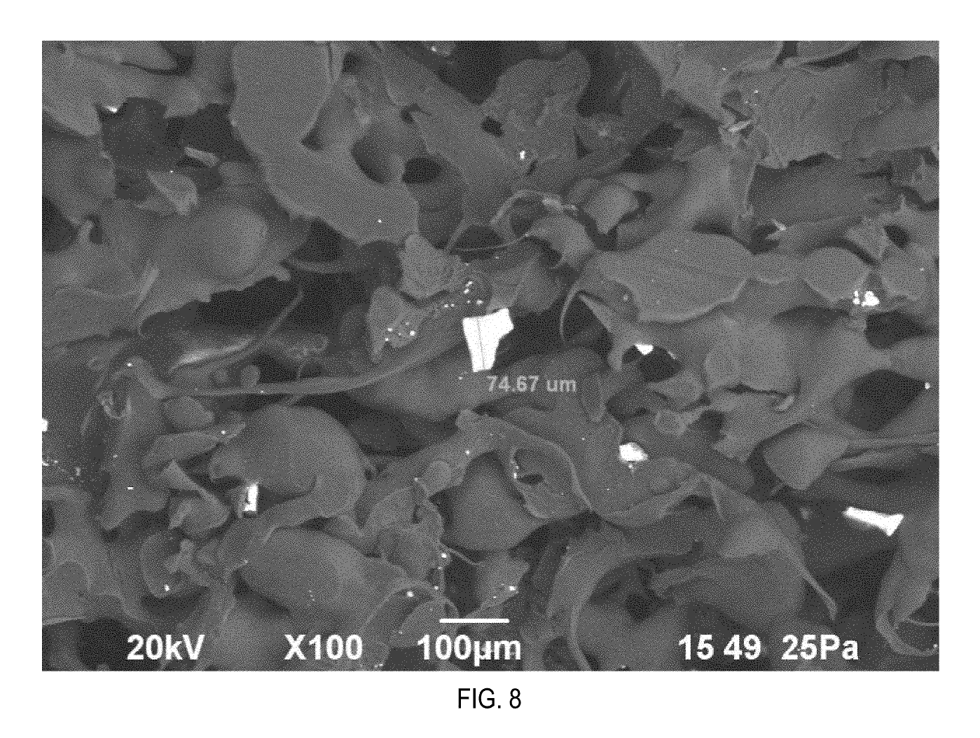

ULPD porous masses were prepared with a particulate mixture consisting of 80% NaCl (approximately 30×70 mesh size) and 20% GUR®2105 (polyethylene particles, available from Ticona). The particulate mixture was placed in a mold lined with 4500 Coresta unit paper and sintered at 220° C. for 15 to 20 minutes. After cooling, the rods were soaked in deionized water for 24 hours to at least substantially remove the fugitive particles (the NaCl particles). The resultant ULPD porous masses maintained their cylindrical structure in a self-supporting structure. FIG. 8 is a scanning electron micrograph of a cross-section of a ULPD porous mass where the dark structures are the GUR®2105 and the bright white structures are the NaCl. This figure illustrates that the NaCl is substantially removed since before soaking the NaCl was 80% of the weight and after soaking FIG. 8 has very little NaCl, likely less than 1% by weight.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
sintering a particulate mixture comprising binder particles at about 5% to about 75% by weight of the particulate mixture and fugitive particles at about 25% to about 90% by weight of the particulate mixture, thereby forming a porous mass; and
substantially removing the fugitive particles from the porous mass, thereby forming an ultra-low pressure drop (ULPD) porous mass with fugitive particles at 0% to about 5% by weight of the ULPD porous mass.

2. The method of claim 1, wherein the ULPD porous mass has an encapsulated pressure drop of less than 1 mm of water/mm length of the ULPD porous mass.

3. The method of claim 1, wherein the fugitive particles are soluble in a solvent selected from the group consisting of water, acetone, methanol, ethanol, propanol, butanol, pentanol, ethylene glycol, propylene glycol, glycerol, acetic acid, formic acid, and any combination thereof, and wherein removing the fugitive particles involves exposing the fugitive particles in the porous mass to the solvent.

4. The method of claim 3, wherein the solvent is at a temperature at or above about 50° C.

5. The method of claim 3, wherein the solvent is at a temperature at or above about 100° C.

6. The method of claim 1, wherein the fugitive particles are degradable by a solvent selected from the group consisting of water, acetone, methanol, ethanol, propanol, butanol, pentanol, ethylene glycol, propylene glycol, glycerol, acetic acid, formic acid, and any combination thereof, and wherein removing the fugitive particles involves exposing the fugitive particles in the porous mass to the solvent.

7. The method of claim 1, wherein the fugitive particles comprise at least one selected from the group consisting of lithium chloride, sodium chloride, potassium chloride, cesium chloride, magnesium chloride, calcium chloride, manganese chloride, iron (II) chloride, iron (III) chloride, nickel chloride, cobalt chloride, copper chloride, zinc chloride, lithium bromide, sodium bromide, potassium bromide, cesium bromide, magnesium bromide, calcium bromide, manganese bromide, iron (II) bromide, iron (III) bromide, nickel bromide, cobalt bromide, copper bromide, zinc bromide, lithium iodide, sodium iodide, potassium iodide, cesium iodide, magnesium iodide, calcium iodide, manganese iodide, iron (II) iodide, iron (III) iodide, nickel iodide, cobalt iodide, copper iodide, zinc iodide, lithium nitrate, sodium nitrate, potassium nitrate, cesium nitrate, magnesium nitrate, calcium nitrate, manganese nitrate, iron (II) nitrate, iron (III) nitrate, nickel nitrate, cobalt nitrate, copper nitrate, zinc nitrate, lithium sulfate, sodium sulfate, potassium sulfate, cesium sulfate, magnesium sulfate, calcium sulfate, manganese sulfate, iron (II) sulfate, iron (III) sulfate, nickel sulfate, cobalt sulfate, copper sulfate, zinc sulfate, sodium carbonate, potassium carbonate, ammonium carbonate, citric acid, sorbic acid, cellulose acetate, sugar, and any combination thereof.

8. The method of claim 1, wherein the fugitive particles have an average diameter of about 100 microns to about 1 mm.

9. The method of 1 claim further comprising:
placing the particulate mixture in a mold cavity before sintering.

10. The method of 1 claim further comprising:
placing the particulate mixture in a mold cavity lined with a wrapper before sintering.

11. The method of claim 1, wherein the particulate mixture further comprises a particulate additive at about 5% to about 70% by weight of the particulate mixture.

12. The method of claim 11, wherein the porous mass consists of the binder particles, the fugitive particles, and the particulate additive.

13. The method of claim 11, wherein the particulate additive comprises at least one selected from the group consisting of active particles, organic particles, and any combination thereof.

14. The method of claim 1 further comprising:
adding an active compound to the ULPD porous mass.

15. The method of claim 1 further comprising:
forming a product comprising the ULPD porous mass, the product being selected from the group consisting of a smoking device filter and a water filter.

16. A method comprising:
introducing a particulate mixture into a mold cavity, the particulate mixture comprising binder particles at about 5% to about 75% by weight of the particulate mixture, fugitive particles at about 25% to about 90% by weight of the particulate mixture, and a particulate additive at about 5% to about 70% by weight of the particulate mixture;
sintering the particulate mixture while in the mold cavity, thereby forming a porous mass;
exposing the porous mass to a solvent to substantially remove the fugitive particles from the porous mass, thereby forming an ultra-low pressure drop (ULPD) porous mass with fugitive particles at 0% to about 5% by weight of the ULPD porous mass and having an encapsulated pressure drop of less than 1 mm of water/mm length of the ULPD porous mass; and
drying the porous mass.

17. The method of claim 16, wherein the particulate mixture further comprises a particulate additive at about 5% to about 70% by weight of the particulate mixture.

18. The method of claim 18, wherein the porous mass consists of the binder particles, the fugitive particles, and the particulate additive.

19. The method of claim 16 further comprising:
adding an active compound to the ULPD porous mass.

20. A filter comprising:
an ultra-low pressure drop (ULPD) porous mass consisting of a plurality of binder particles mechanically bound at a plurality of sintered contact points, wherein the ULPD porous mass has a pressure drop across of less than 1 mm of water/mm of ULPD porous mass length.
